(19) United States
(12) Patent Application Publication
(10) Pub. No.: US 2017/0354176 A1
(43) Pub. Date: Dec. 14, 2017

(54) FOOD OR BEVERAGE COMPOSITION

(71) Applicant: J-OIL MILLS, INC., Tokyo (JP)

(72) Inventors: Yuya NAGAHATA, Tokyo (JP); Isao KOBAYASHI, Tokyo (JP); Masahiro INOUE, Tokyo (JP); Yuko TOUSEN, Tokyo (JP); Yoshiko ISHIMI, Tokyo (JP)

(21) Appl. No.: 15/602,998

(22) Filed: May 23, 2017

(30) Foreign Application Priority Data
Jun. 14, 2016 (JP) 2016-118048

(51) Int. Cl. A23L 29/30; A23L 7/109; A23L 33/21; C08B 30/20; A23L 2/52; A23L 29/212; A23L 7/10

(52) U.S. Cl. CPC A23L 29/35; A23L 29/212; A23L 7/109; A23L 7/10; C08B 30/20; A23L 2/52; A23L 33/21

(57) ABSTRACT

Provided is a food or beverage composition for suppressing an expression of an interleukin 7 receptor (IL-7R) gene, including a resistant starch-rich starch satisfying the following conditions (a), (b), (c) and (d) as an active ingredient:
(a) having a resistant starch content of 60% or more, as determined by the AOAC Official Method 2002.02 for measuring resistant starch,
(b) having a molecular weight peak more than or equal to 6×10³ and less than or equal to 4×10⁴,
(c) having a molecular weight dispersity more than or equal to 1.5 and less than or equal to 6.0, and
(d) having a gelatinization enthalpy at 50° C. to 130° C. of 10 J/g or less, as measured by differential scanning calorimetry.

This application is based on Japanese patent application No. 2016-118048 filed on Jun. 14, 2016, the content of which is incorporated hereinto by reference.

### BACKGROUND

### Tehcnical Field

The present invention relates to a food or beverage composition.

### Related Art

Starch is readily digestible in general, but contains an indigestible fraction called resistant starch (RS).

International Publication No. WO 2011/045902 describes a technique to provide a starch which has a high content of resistant starch excellent in terms of a digestion resistance in vivo and exhibits an excellent neat stability of resistant starch.

On the other hand, an estrogen deficiency is a major risk factor for osteoporosis, which is associated with a bone inflammation and bone resorption.

In addition, a bone metabolism regulating action of soy isoflavone has been investigated in Yoriko Nishide et. al., “Possible role of S-equol on bone loss via amelioration of inflammatory indices in ovariectomized mice”, J. Clin. Biochem. Nutr. , July 2013, Vol. 53, No. 1, pp 41 to 48, and Susan M Potter et al., “Soy protein and isoflavones: their effects on blood lipids and bone density in postmenopausal women”, Am J Clin Nutr, December 1998, Vol. 68 (6 Suppl) , pp 1375S to 1379S, as a technique for a prevention of osteoporosis.

Yoriko Nishide et al., “Possible role of S-equol on bone loss via amelioration of inflammatory indices in ovariectomized mice”, J. Clin. Biochem. Nutr., July 2013, Vol. 53, No, 1, pp 41 to 48 describes that an expression of eight types of genes in bone marrow was suppressed in a test in which equol, which is a metabolite of isoflavone, has been administered to ovariectomized (OVX) mice. In addition, Susan M Potter et al., “Soy protein and isoflavones: their effects on blood lipids and bone density in postmenopausal women”, Am J Clin Nutr, December 1998, 68 (6 Suppl), pp 1375S to 1379S describes the study results for an effect of isoflavone on an improvement of a bone density.

Further, Japanese Unexamined Patent Publication No. 2009-107995 describes a technique relating to an osteoclast differentiation inhibitor containing epigallocatechin gallate as an active ingredient. In addition, it is described in paragraph 0003 of the same document that “the balance of activities between osteoclasts and osteoblasts in bone tissues is maintained under normal conditions, whereby a shape and quantity of a bone are maintained. When the above-mentioned balance is broken due to a bone resorption rate becoming higher than a bone formation rate, tiny pores frequently occur in the bone and the bone density decreases, and consequently the strength of the bone becomes weaker and the risk of fragile fracture becomes higher. Such a condition is osteoporosis.” It is known that the balance of bone metabolism is important for the prevention of osteoporosis.

### SUMMARY

On the other hand, the relationship between osteoporosis and resistant starch was not clear.

The present invention is to provide a novel food or beverage composition which is capable of suppressing a reduction of a bone density, an inflammation of a bone marrow or an expression of a bone marrow inflammation-related gene possibly responsible for osteoporosis, or is capable of improving a bone metabolic balance.

In one embodiment, there is provided a food or beverage composition for suppressing an expression of an interleukin 7 receptor (IL-7R) gene, including a resistant starch-rich starch satisfying the following conditions (a), (b), (c) and (d) as an active ingredient:
(a) having a resistant starch content of 60% or more, as determined by the AOAC Official Method 2002.02 for measuring resistant starch,
(b) having a molecular weight peak more than or equal to 6×10³ and less than or equal to 4×10⁴,
(c) having a molecular weight dispersity more than or equal to 1.5 and less than or equal to 6.0, and
(d) having a gelatinization enthalpy at 50° C. to 130° C. of 10 J/g or less, as measured by differential scanning calorimetry.

In another embodiment, there is provided a food or beverage composition for suppressing an inflammation of a bone marrow, including a resistant starch-rich starch satisfying the following conditions (a), (b), (c) and (d) as an active ingredient:
(a) having a resistant starch content of 60% or more, as determined by the AOAC Official Method 2002.02 for measuring resistant starch,
(b) having a molecular weight peak more than or equal to 6×10³ and less than or equal to 4×10⁴,
(c) having a molecular weight dispersity more than or equal to 1.5 and less than or equal to 6.0, and
(d) having a gelatinization enthalpy at 50° C. to 130° C. of 10 J/g or less, as measured by differential scanning calorimetry.

In yet another embodiment, there is provided a food or beverage composition for suppressing a reduction of a bone density, including a resistant starch-rich starch satisfying the following conditions (a), (b), (c) and (d) as an active ingredient:
(a) having a resistant starch content of 60% or more, as determined by the AOAC Official Method 2002.02 for measuring resistant starch,
(b) having a molecular weight peak more than or equal to 6×10³ and less than or equal to 4×10⁴,
(c) having a molecular weight dispersity more than or equal to 1.5 and less than or equal to 6.0, and
(d) having a gelatinization enthalpy at 50° C. to 130° C. of 10 J/g or less, as measured by differential scanning calorimetry.

In still yet another embodiment, there is provided a food or beverage composition for improving a bone metabolic balance, including a resistant starch-rich starch satisfying the following conditions (a), (b), (c) and (d) as an active ingredient:
(a) having a resistant starch content of 60% or more, as determined by the AOAC Official Method 2002.02 for measuring resistant starch,
(b) having a molecular weight peak more than or equal to 6×10³ and less than or equal to 4×10⁴,
(c) having a molecular weight dispersity more than or equal to 1,5 and less than or equal to 6.0, and
(d) having a gelatinization enthalpy at 50° C. to 130° C. of 10 J/g or less, as measured by differential scanning calorimetry.

Any combination of these configurations and a conversion of expressions of the present invention among methods, applications, or the like are also effective as embodiments of the present invention.

For example, according to the present invention, there is provided use of a resistant starch-rich starch satisfying the foregoing conditions (a), (b), (c) and (d) for a food or beverage composition for suppressing an expression of an interleukin 7 receptor (IL-7R) gene, a food or beverage composition for suppressing an inflammation of bone marrow, a food or beverage composition for suppressing a reduction of a bone density, or a food or beverage composition for improving a bone metabolic balance.

Further, according to the present invention, there is provided an IL-7R gene expression inhibitor, including a resistant starch-rich starch satisfying the foregoing conditions (a), (b), (c) and (d).

According to the present invention, there is provided a bone marrow inflammation inhibitor, including a resistant starch-rich starch satisfying the foregoing conditions (a), (b), (c) and (d).

According to the present invention, there is provided a bone density reduction inhibitor, including a resistant starch-rich starch satisfying the foregoing conditions (a), (b), (c) and (d).

According to the present invention, there is provided a bone metabolic balance improving agent, including a resistant starch-rich starch satisfying the foregoing conditions (a), (b), (c) and (d).

Further, according to the present invention, there is provided use of the foregoing IL-7R gene expression inhibitor, the foregoing bone marrow inflammation inhibitor, the foregoing bone density reduction inhibitor, or the foregoing bone metabolic balance improving agent for a food or beverage, a feed, or a medicine.

According to the present invention, it is possible to provide a novel food or beverage composition which is capable of suppressing the reduction of the bone density possibly responsible for osteoporosis, the inflammation of the bone marrow, or the expression of the bone marrow inflammation-related gene, or is capable of improving the bone metabolic balance.

### BRIEF DESCRIPTION OF THE DRAWINGS

The above and other objects, advantages and features of the present invention will be more apparent from the following description of certain preferred embodiments taken in conjunction with the accompanying drawings, in which:

FIGS. 1A to 1D are diagrams showing measurement results of expression levels of bone marrow inflammation-related genes in Examples.

FIGS. 2A to 2D are diagrams showing measurement results of a femoral bone density in Examples.

### DETAILED DESCRIPTION

The invention will be new described herein with reference to illustrative embodiments. Those skilled in the art will recognize that many alternative embodiments can be accomplished using the teachings of the present invention and that the invention is not limited to the embodiments illustrated for explanatory purposes.

Hereinafter, embodiments of the present invention will be described with reference to specific examples of individual ingredients. Note that individual ingredients may be used alone or in combination of two or more thereof.

First, the resistant starch-rich starch used in a food or beverage composition in the present embodiment will be described.

### (Resistant Starch-Rich Starch)

In the present embodiment, the resistant starch-rich starch satisfies the following conditions (a), (b), (c) and (d).
(a) having a resistant starch content of 60% or more, as determined by the AOAC Official Method 2002.02 for measuring resistant starch,
(b) having a molecular weight peak more than or equal to 6×10³ and less than or equal to 4×10⁴,
(c) having a molecular weight dispersity more than or equal to 1.5 and less than or equal to 6.0, and
(d) having a gelatinization enthalpy at 50° C. to 130° C. of 10 J/g or less, as measured by differential scanning calorimetry.

The resistant starch-rich starch used in the present embodiment satisfies the foregoing condition (a), and has a significantly higher content of resistant starch as compared with those obtained by the conventional methods of production.

From the viewpoint of further increasing the content of resistant starch, the resistant starch content of the resistant starch-rich starch in the present embodiment, as measured by the AOAC Official Method 2002.02 for measuring resistant starch, is 60% or more, preferably 62% or more, and more preferably 65% or more. The upper limit of the resistant starch content of the resistant starch-rich starch in the present embodiment is not limited and may be 100% or less, for example 90% or less.

Note that the resistant starch content is defined as weight of resistant starch relative to dry weight of sample (w/w).

By satisfying the foregoing conditions (b) and (c), it is possible to stably increase the content of resistant starch in starch.

Among them, the foregoing condition (b) specifies a range of a molecular weight of the resistant starch-rich starch.

Starches having a resistant starch content exceeding 60% are stably obtainable by setting a molecular weight peak to fall within the range of more than or equal to 6×10³ and less than or equal to 4×10⁴.

From the viewpoint of more stably obtaining the resistant starch-rich starch, the molecular weight peak may be, for example, 6.5×10³ or more and preferably 8×10³ or more. From the viewpoint of still more stably obtaining the resistant starch-rich starch, the molecular weight peak may be, for example, 3.6×10⁴ or less, preferably 2.5×10⁴ or less, and more preferably 1.5×10⁴ or less.

Next, the foregoing condition (c) specifies a molecular weight dispersity.

The molecular weight dispersity in the condition (c) refers to a ratio Mw/Mn of weight-average molecular weight Mw relative to number-average molecular weight Mn. By configuring to satisfy the foregoing condition (c), it is possible to stably increase the resistant starch content. In addition, a fraction having a low molecular weight or a fraction having a high molecular weight may be suppressed from being excessively abundant, so that a food or beverage composition may be suppressed from being too floury or too hard in texture.

From the viewpoint of improving a desirability of the a texture such as a floury texture when ingesting a food or beverage composition, the lower limit of the molecular weight dispersity is set to 1.5 or more, preferably 2.0 or more, and more preferably 3.0 or more.

On the other hand, from, a viewpoint of further stably increasing the resistant starch content, the upper limit of the molecular weight dispersity is 6.0 or less, preferably 5.5 or less, and more preferably 5.0 or less.

Thus, from the viewpoint of a balance between the resistant starch content and the texture, the molecular weight dispersity in the present embodiment is preferably more than or equal to 1.5 and less than or equal to 6.0, preferably more than or equal to 2.0 and less than or equal to 5.5, and more preferably more than or equal to 3.0 and less than or equal to 5.0.

The molecular weight of starch may be measured, for example, by gel permeation chromatography (GPC) (in terms of pullulan as a standard).

Next, the condition (d) will be explained.

In the present embodiment, since the condition (d) is satisfied, the resistant starch content may originally be high and a resistant starch content even after a heat treatment may also stay high,

Specifically, it is also possible to set the resistant starch content after hearting at 200° C. for 20 minutes to, for example, 55% or more, preferably 60% or more, and more preferably 63% or more.

Herein, the gelatinization enthalpy is energy required for a starch to be gelatinized by heating. When the starch and water are heated together, the starch is gelatinized at a certain temperature. Since energy is required for the gelatinization, an endothermic reaction occurs. In Differential Scanning Calorimetry (DSC), an endothermic energy amount associated with a temperature change is measured as a peak, and a peak area is calculated as the gelatinization enthalpy. The gelatinization enthalpy can be used as an index of a heat stability, for starches similar to each other in terms of the gelatinization temperature, the peak of a molecular weight, and the molecular weight dispersity.

A smallness of the endothermic peak observed in DSC is one feature of the resistant starch-rich starch in the present embodiment, which is specifically 10 J/g or smaller, preferably 8 J/g or smaller, and more preferably 6 J/g or smaller. By doing so, a food or beverage composition which ensures a high content of resistant starch even after subjecting to a heat treatment is obtainable in a stable manner. There is no limitation on the lower limit of the gelatinization enthalpy which may be, for example 1 J/g or more.

Since the food or beverage composition of the present embodiment includes a resistant starch-rich starch satisfying all of the foregoing conditions (a) to (d) as an active ingredient, it is possible to obtain a food or beverage composition which contains a high percentage of resistant starch having an effect of suppressing an expression of an IL-7R gene, an effect of suppressing an inflammation of a bone marrow, an effect of suppressing a reduction of a bone density, or an effect of improving a bone metabolic balance and exhibits an excellent thermal stability of the resistant

Next, the method of producing the above-mentioned resistant starch-rich starch will be described. The resistant starch-rich starch in the present embodiment may be produced, for example, according to the method described in International Publication No. WO 2011/045902.

In the present specification, the individual terms are defined as follows, unless otherwise specifically stated. Note also that the resistant starch may occasionally be referred to as “RS” in the present specification.

Slurry concentration: a ratio of a dry weight of a starch relative to a weight of a starch slurry (w/w);

Acid normality: normality of an acid in water, including a water content derived from a starch, in a reaction solution. Here, the water content is a ratio of a water content relative to a wet weight of the starch (w/w).

Resistant, starch content: a ratio of a weight of a resistant starch relative to a dry weight of a sample (w/w); and

Resistant starch-rich, starch: a starch having a resistant starch content of 60% or more.

In the present embodiment, the above-mentioned resistant starch-rich starch is, for example, an acid-treated product of an amylose-rich starch having an amylose content of 40% or more, preferably an acid-treated high-amylose corn starch.

The acid-treated product of an amylose-rich starch is obtainable, for example, by using amylose-rich starch having an amylose content of 40% or more as a raw material, and subjecting the raw material to an acid treatment in an aqueous inorganic acid solution.

The sources of the amylose-rich starch used as a raw material may be corn, potato, rice, wheat, sweat potato, tapioca and other arbitrary sources. From the viewpoint of an easy availability, those derived from corn are preferable. Specifically, high-amylose corn starch is preferable. The high-amylose corn starch is a corn starch enhanced in the amylose; content by selective breeding, and those having an amylose content of 40% or more, and 70% or more, are currently available. From the viewpoint of further stably increasing the resistant starch content in the resistant starch-rich starch, any starch having an amylose content of, for example, 40% or more, preferably 60% or more may be used.

In the acid treatment, starch as a raw material and water are charged into a reactor. Alternatively, an acidic water preliminarily prepared by dissolving an inorganic acid in water, and starch as a raw material are charged into a reactor. From the viewpoint of allowing the acid treatment to proceed more stably, it is preferable that the whole portion of starch during the reaction is uniformly dispersed in the aqueous phase, or stays in the form of slurry. For this purpose, the concentration of the starch slurry to be subjected to the acid treatment is adjusted to, for example, 50 mass % or less, preferably to more than or equal to 20 mass % and less than or equal to 40 mass %. An excessively high slurry concentration may result in an increased viscosity of the slurry which in turn may make it difficult to uniformly stir the slurry.

Specific examples of the acid to be used in the acid treatment include inorganic acids such as hydrochloric acid, sulfuric acid, and nitric acid, without limiting species and purity.

The acid treatment reaction is carried out by selecting an appropriate temperature and am appropriate acid concentration, so that the resulting acid-treated starch satisfies the foregoing conditions (a) to (d). In the present embodiment, for example, the inorganic acid concentration, reaction temperature and reaction time in the process of acid treatment are set to specific conditions. Hereinafter, the individual conditions will be specifically described.

First, the acid treatment time is set so as to satisfy the foregoing conditions (a) to (d). From the viewpoint of more reliably suppressing deterioration during the reaction, the time necessary for the acid treatment is set to be within, for example, 3 clays, and preferably 2 days.

Moreover, the concentration of the inorganic acid and the reaction temperature for the acid treatment is set to conditions such that, for example, the following Formula (1) is satisfied.

(5.54×(4.20)^{(T-40)/10)})^{(-0.879})≦C<−0.000016×T³+0.00068×T²−0.028×T+4.3 (1)

(In the above Formula (1), T is a reaction temperature (° C.), C is normality (N) of an inorganic acid in an aqueous inorganic acid solution.)

When both the normality of the inorganic acid and the reaction temperature are too high, the resistant starch content may not be sufficiently increased in some cases. On the contrary, when they are too low, it takes too much time for the acid treatment reaction.

By setting the conditions satisfying the Formula (1), it is possible to efficiently and stably increase the resistant starch content.

Furthermore, the reaction time in the acid treatment may be specifically determined from two factors including the reaction temperature and the acid normality by the following Formula (2).

13.0×C^{(-1.14)}×(1/4.2)^{(T-40/10}≦t≦180×C^{(-1.58)}×(1/4.2)^{(T-}40)/10 (2)

(In the above Formula (2), T is a reaction temperature (° C.), C is normality (N) of an inorganic acid in an aqueous inorganic acid solution, and t is a reaction time (hour).)

The Formula (2) was derived by way of experiment, and describes that a doubled acid normality shortens the shortest time for obtaining the resistant starch-rich starch by a factor of 1/2.2, the longest time by a factor of 1/3, and that elevation of the reaction temperature by 10° C. shortens both of the shortest time and longest time by a factor of 1/4.2.

The production conditions of the resistant starch-rich starch are expressed by three factors of a reaction temperature, an acid normality and a reaction time. The upper limits and the lower limits of the reaction temperature and the acid normality adopted to the Formula (2) are determined by the Formula (1).

By proceeding the acid treatment using amylose-rich starch which has an amylose content of 40% or more as a raw material, while setting specific conditions respectively for the reaction temperature, the acid normality and the reaction time, the resistant starch content can be dramatically increased. It is also made possible to increase the resistant starch content of an amylose-rich starch with high efficiency.

Due to satisfying the conditions (a) to (d), the thus-obtainable resistant starch-rich starch has a high ratio of resistant starch and an excellent heat stability of the resistant starch and is capable of suppressing the expression of an IL-7R gene which is a bone marrow inflammation-related gene.

In addition, due to having a high resistant starch content and an excellent heat stability of the resistant starch and being capable of suppressing the expression of an IL-7R gene, the resistant starch-rich starch satisfying the conditions (a) to (d) is capable of suppressing an inflammation of the bone marrow or a reduction of a bone density and improving a bone metabolic balance. This is because IL-7 is a major inflammatory cytokine causing a decrease in bone mass due to estrogen deficiency, and suppression of the gene expression of IL-7R which is a receptor for IL-7 leads to weakening of the action of IL-7, thereby capable of suppressing the inflammation of the bone marrow or the reduction of the bone density and improving the bone metabolic balance.

Further, the resistant starch-rich starch satisfying the conditions (a) to (d) is effective as, for example, an IL-7R gene expression inhibitor, preferably an bone marrow IL-7R gene expression inhibitor, a bone marrow inflammation inhibitor, a bone density reduction inhibitor, or a bone metabolic balance improving agent.

Further, the resistant starch-rich starch satisfying the conditions (a) to (d) is preferably used as an ingredient in a food or beverage composition.

Hereinafter, a food or beverage composition for suppressing an expression of an IL-7R gene, a food or beverage composition for suppressing an inflammation of a bone marrow, a food or beverage composition for suppressing a reduction of a bone density, and a food or beverage composition for improving a bone metabolic balance will be described as specific examples of the food or beverage composition.

### (Food or Beverage Composition for Suppressing Expression of IL-7R Gene)

In the present embodiment, the food or beverage composition for suppressing the expression of the IL-7R gene contains the resistant starch-rich starch satisfying the above-mentioned conditions (a), (b), (c) and (d) as an active ingredient. Therefore, the food or beverage composition for suppressing the expression of the IL-7R gene in the present embodiment can suppress the expression of an IL-7R gene which is a bone marrow inflammation-related gene.

From the viewpoint of enhancing a suppressing effect on the expression of an IL-7R gene in the bone marrow, the content, of the resistant starch-rich starch in the food or beverage composition for suppressing the expression of the IL-7R gene is, for example, 0.1 mass % or more, preferably 1 mass % or more, more preferably 5 mass % or more, even more preferably 10 mass % or more, and still more preferably 15 mass % or more with respect to the total amount of the food or beverage composition for suppressing the expression of the IL-7R gene.

The upper limit of the content of the resistant starch-rich starch in the food or beverage composition for suppressing the expression of the IL-7R gene is not limited and is, for example, less than 100 mass %, preferably 90 mass % or less with respect to the total amount of the food or beverage composition for suppressing the expression of the IL-7R gene. Further, the content of the resistant starch-rich starch in the food or beverage composition for suppressing the expression of the IL-7R gene may be, for example, 60 mass % or less, preferably 40 mass % or less, and more preferably 30 mass % or less.

In addition, the ingredients other than the resistant starch-rich starch contained in the food or beverage composition for suppressing the expression of the IL-7R gene may be any ingredient used in foods and beverages. Specific examples thereof include:
starches such as corn starch, high-amylose corn starch, tapioca starch, potato starch, wheat; starch and rice starch other than the above-mentioned resistant starch-rich starch, or processed starches thereof which are obtained by subjecting to processing such as acetylation, hydroxypropylation, or phosphate crosslinking;
cereal flours such as wheat flour, barley flour, soy flour, and rice flour;
dietary fibers such as insoluble dietary fiber, water-soluble dietary fiber, and indigestible oligosaccharide;
polysaccharides such as pectin, guar gum, and cellulose other than the foregoing;
monosaccharides or oligosaccharides such as glucose, fructose, suerose, lactose, and trehalose;
sweeteners such as aspartame, acesulfame potassium, and stevia other than the foregoing monosaccharides or oligosaccharide; proteins or peptides such as casein, albumin, and a soy protein;
fats and oils, for example edible fats and oils such as corn oil, olive oil, coconut oil, linseed oil, perilla oil, sesame oil, and palm oil, and processed fats and oils such as butter, shortening, and margarine;
minerals such as sodium, potassium, calcium, magnesium, and zinc;
vitamins such as vitamin A, vitamin B group, vitamin C, vitamin D group, vitamin E, and vitamin K group;
amino acids such as cystine, glutamic acid or a salt thereof, and glycine;
choline salts such as choline bitartrate;
antioxidants such as t-butylhydroquinone and rosemary extract;
pH adjusting agents such as organic acids, for example citric acid and malic acid, inorganic acids and inorganic salts;
surfactants such as lecithin and glycerin fatty acid ester;
isoflavones such as daidzein and equol;
perfume; and
water.

Among them, the insoluble dietary fiber may be, for example, one or two or more selected from the group consisting of cellulose, hemicellulose, lignin, chitosan, chitin, and cellulose derivatives such as carboxymethyl cellulose and hydroxypropyl cellulose. Among them, cellulose is a main component constituting cell walls of plants and yeasts, and is easy to be used and is a representative compound of insoluble dietary fibers. The sources of the insoluble dietary fibers are not limited, and those derived from plants, those derived from animals, those derived from fungi, and the like may be used.

From the viewpoint of availability, the insoluble dietary fiber is preferably one or more or two selected from cellulose and derivatives thereof, and more preferably cellulose.

From the viewpoint of obtaining an IL-7R gene expression suppressor effect and improving an intestinal environment, it is also preferred that the food or beverage composition for suppressing the expression of the IL-7R gene contains one, or two or more insoluble dietary fibers.

The content of the insoluble dietary fiber in the food or beverage composition for suppressing the expression of the IL-7R gene may be set according to a form of a food or beverage composition and may be appropriately set within the range where an effect of suppressing the expression of an IL-7R gene is sufficiently obtainable. The content of the insoluble dietary fiber is, for example, 0.1 mass % or more, preferably 1 mass % or more, and more preferably 3 mass % or more with respect to the total amount of the food or beverage composition for suppressing the expression of the IL-7R gene. In addition, the content of the insoluble dietary fiber is, for example, 30 mass % or less and preferably 20 mass % or less with respect to the total amount of the food or beverage composition for suppressing the expression of the IL-7R gene.

The food or beverage composition for suppressing the expression of the IL-7R gene can be obtained by mixing the above-mentioned resistant starch-rich starch and other raw materials in a predetermined order.

In the process of producing the food or beverage composition for suppressing the expression of the IL-7R gene, it may also carry out predetermined cooking steps such as heating, drying, mixing, and dispersing in water, fat and oil, or the like.

There is no limitation on the form of the resulting food or beverage composition for suppressing the expression of the IL-7R gene, and such a food or beverage composition may be formulated into a solid-like composition such as a granulated substance as exemplified by a powder or a granule, a tablet, or a capsule;
a liquid-like composition such as a dispersion or a suspension;
a jelly-like composition;
a paste-like composition; or the like.

In addition, an intake amount of the food or beverage composition for suppressing the expression of the IL-7R gene may be set depending on, for example, the content of the resistant starch-rich starch which is an active ingredient in the food or beverage composition for suppressing the expression of the IL-7R gene, an age and a physical condition of a consumer, an intake method, and the like.

From the viewpoint of enhancing a suppressor effect on the expression of an IL-7R gene, the intake amount of the food or beverage composition may be set to, for example, 50 mg a day per 1 kg of body weight or more, preferably 100 mg a day per 1 kg of body weight or more in terms of an active ingredient for an adult.

The upper limit of the intake amount of the food or beverage composition for suppressing the expression of the IL-7R gene is not limited, but it may be set to, for example, 5 g a day per 1 kg of body weight or less in terms of an active ingredient for an adult.

Those who ingest the food or beverage composition for suppressing the expression of the IL-7R gene are not limited in age and gender, but are preferably those who are prone to cause osteoporosis due to estrogen deficiency and particularly preferably postmenopausal women.

In the present embodiment, it is possible to effectively suppress the expression of an IL-7R gene since the food or beverage composition for suppressing the expression of the IL-7R gene contains the above-mentioned resistant starch-rich starch as an active ingredient.

### (Food or Beverage Composition for Suppressing the Inflammation of the Bone Marrow)

In the present embodiment, the food or beverage composition for suppressing the inflammation of the bone marrow contains a resistant starch-rich starch satisfying the above-mentioned conditions (a), (b), (c) and (d) as an active ingredient.

From the viewpoint of enhancing a bone marrow inflammation-suppressing effect, the content of the above-mentioned resistant starch-rich starch in the food or beverage composition for suppressing the inflammation of the bone marrow is, for example, 0.1 mass % or more, preferably 1 mass % or more, more preferably 5 mass % or more, even more preferably 10 mass % or more, and still more preferably 15 mass % or more with respect to the total amount of the food or beverage composition for suppressing the inflammation of the bone marrow. The upper limit of the content of the resistant starch-rich starch in the food or beverage composition for suppressing the inflammation of the bone marrow is not limited and is, for example, less than 100 mass %, preferably 90 mass % or less with respect to the total amount of the food or beverage composition for suppressing the inflammation of the bone marrow. In addition, the content of the resistant starch-rich starch in the food or beverage composition for suppressing the inflammation of the bone marrow may be set to, for example, 60 mass % or less, preferably 40 mass % or less, and more preferably 30 mass % or less.

In addition, the ingredients other than the resistant starch-rich starch contained in the food or beverage composition for suppressing the inflammation of the bone marrow may be any ingredient used in foods or beverages, and specific examples thereof include those mentioned above as the ingredients contained in the food or beverage composition for suppressing the expression of the IL-7R gene.

The food or beverage composition for suppressing the inflammation of the bone marrow can be obtained by, for example, the method mentioned above for the food or beverage composition for suppressing the expression of the IL-7R gene.

There is no limitation on a form of the resulting food or beverage composition for suppressing the inflammation of the bone marrow. For example, the food or beverage composition for suppressing the inflammation of the bone marrow may be formulated into the form described above as the form of the food or beverage composition for suppressing the expression of the IL-7R gene.

In addition, the intake amount of the food or beverage composition for suppressing the inflammation of the bone marrow may be set depending on, for example, the content of the resistant starch-rich starch which is an active ingredient in the food or beverage composition for suppressing the inflammation of the bone marrow, the age and physical condition of the consumer, the intake method, and the like. For example, the intake amount may be set to the intake amount mentioned above as the intake amount of the food or beverage composition for suppressing the expression of the IL-7R gene.

Those who ingest the food or beverage composition for suppressing the inflammation of the bone marrow are not-limited in age and gender, but are preferably those who are prone to cause osteoporosis due to estrogen deficiency, and particularly preferably postmenopausal women.

In the present, embodiment, it is possible to effectively suppress the inflammation in the bone marrow since the food or beverage composition for suppressing the inflammation of the bone marrow contains the above-mentioned resistant starch-rich starch as an active ingredient

### (Food or Beverage Composition for Suppressing Reduction of Bone Density)

In the present embodiment, the food or beverage composition for suppressing the reduction of the bone density contains a resistant starch-rich starch satisfying the above-mentioned conditions (a), (b), (c) and (d) as an active ingredient. In addition, the food or beverage composition for suppressing the reduction of the bone density is excellent, for example, for suppressing a decrease in bone density of a femur.

From the viewpoint of enhancing the effect of suppressing a decrease in bone density, the content of the above-mentioned resistant starch-rich starch in the food or beverage composition for suppressing the reduction of the bone density is, for example, 0.1 mass % or more, preferably 1 mass % or more, more preferably 5 mass % or more, still more preferably 10 mass % or more, and even further more preferably 15 mass % or more with respect to the total amount of the food or beverage composition for suppressing the reduction of the bone density. The upper limit of the content of the resistant starch-rich starch in the food or beverage composition for suppressing the reduction of the bone density is not limited and may be, for example, less than 100 mass % and preferably 90 mass % or less with respect to the total amount of the food or beverage composition for suppressing the reduction of the bone density. Further, the content of the resistant starch-rich starch in the food or beverage composition for suppressing the reduction of the bone density may be set to, for example, 60 mass % or less, preferably 40 mass % or less, and more preferably 30 mass % or less.

In addition, the ingredients other than the resistant starch-rich starch contained in the food or beverage composition for suppressing the reduction of the bone density may be any ingredient used in foods or beverages, and specific examples thereof include those mentioned above as the ingredients contained in the food or beverage composition for suppressing the expression of the IL-7R gene.

The food or beverage composition for suppressing the reduction of the bone density can be obtained by, for example, the method described above for the food or beverage composition for suppressing the expression of the IL-7R gene.

There is no limitation on a form of the food or beverage composition for suppressing the reduction of the bone density. For example, the food or beverage composition for suppressing the reduction of the bone density may be formulated into the form described above as a form of the food or beverage composition for suppressing the expression of the IL-7R gene.

In addition, the intake amount of the food or beverage composition for suppressing the reduction of the bone density may be set depending on, for example, the content of the resistant starch-rich starch which is an active ingredient in the food or beverage composition for suppressing the reduction of the bone density, the age and physical condition of the consumer, the intake method, and the like. For example, the intake amount of the food or beverage composition for suppressing the reduction of the bone density may be set to the intake amount described above as the intake amount of the food or beverage composition for suppressing the expression of the IL-7R gene.

Those who ingest food or beverage composition for suppressing the reduction of the bone density are not limited in age and gender, but are preferably those who are prone to cause osteoporosis due to estrogen deficiency, and particularly preferably postmenopausal women.

In the present embodiment, it is possible to effectively suppress a decrease in bone density since the food or beverage composition for suppressing the reduction of the bone density contains the above-mentioned resistant starch-rich starch as an active ingredient. More specifically, it is also possible to suitably suppress a reduction of bone density in the femur by using the food or beverage composition for suppressing the reduction of the bone density according to the present embodiment.

### (Food or Beverage Composition for Improving Bone Metabolic Balance)

In the present embodiment, the food or beverage composition for improving the bone metabolic balance contains a resistant starch-rich starch satisfying the above-mentioned conditions (a), (b), (c) and (d) as an active ingredient.

From the viewpoint of enhancing an effect of improving the bone metabolic balance, the content of the above-mentioned resistant starch-rich starch in the food or beverage composition for improving the bone metabolic balance is, for example, 0.1 mass % or more, preferably 1 mass % or more, more preferably 5 mass % or more, still more preferably 10 mass % or more, and further more preferably 15 mass % or more with respect to the total amount of the food or beverage composition for improving the bone metabolic balance. The upper limit of the content of the resistant starch-rich starch in the food or beverage composition for improving the bone metabolic balance is not limited, and it is, for example, less than 100 mass % and preferably 90 mass % or less with respect to the total amount of the food or beverage composition for improving the bone metabolic balance. Further, the content of the resistant starch-rich starch in the food or beverage composition for improving the bone metabolic balance may be set to, for example, 60 mass % or less, preferably 40 mass % or less, and more preferably 30 mass % or less with respect to the total amount of the food or beverage composition for improving the bone metabolic balance.

In addition, the ingredients other than the resistant starch-rich starch contained in the food or beverage composition for improving the bone metabolic balance may be any ingredient used in foods or beverages, and specific examples thereof include those mentioned above as the ingredients contained in the food or beverage composition for suppressing the expression of the IL-7R gene.

The food or beverage composition for improving the bone metabolic balance can be obtained, by, for example, the method described above for the food or beverage composition for suppressing the expression of the IL-7R gene.

There is no limitation on a form of the food or beverage composition for improving the bone metabolic balance. For example, the food or beverage composition for improving the bone metabolic balance may be formulated into the form described above as a form of the food or beverage composition for suppressing the expression of the IL-7R gene,

In addition, the intake amount of the food or beverage composition for improving the bone metabolic balance may be set depending on, for example, the content of the resistant starch-rich starch which is an active ingredient in the food or beverage composition for improving the bone metabolic balance, the age and physical condition of the consumer, the intake method, and the like. For example, the intake amount of the food or beverage composition for improving the bone metabolic balance may be set to the intake amount described above as the intake amount of the food or beverage composition for suppressing the expression of the IL-7R gene.

Those who ingest the food or beverage composition for improving the bone metabolic balance are not limited in age and gender, but are preferably those who are prone to cause osteoporosis due to estrogen deficiency, and particularly preferably postmenopausal women,

In the present embodiment, it is possible to effectively improve bone metabolic balance since the food or beverage composition for improving the bone metabolic balance contains the above-mentioned resistant starch-rich starch as an active ingredient.

### (Food and Beverage)

In the present embodiment, specific examples of foods and beverages in the food or beverage composition which suppresses the expression of an IL-7R gene, the food or beverage composition which can suppress inflammation of bone marrow, the food or beverage composition which can suppress a reduction of bone density, or the food or beverage composition which improves bone metabolic balance include:
dairy products such as yogurt, cheese, and powdered milk;
soups such as powder soup and retort soup;
sweets such as western confectionery, for example, puddings, cookies, biscuits, crackers, cakes, chocolates, candies, cereal bars, granola, and corn puffs, and Japanese-style confectionery;
bread, pizza, and noodles;
processed livestock meat goods such as bacon, ham, sausage, and hamburger;
seafood processed goods such as fish minced and steamed (Kamaboko), tube-shaped fish-paste cake (Chikuwa), and fish sausage;
seasonings such as Japanese fermented soybean paste (Miso) and salted rice malt;
beverages such as fruit juice beverage, milk beverage, cold beverage such as sports beverage, tea, alcoholic beverage, and smoothie; and
supplements.

Further, in the present embodiment, the food or beverage may be a food for special dietary use such as a food for specified health use, a food with health claims such as a food with nutrient function claims, or a food for patients.

Further, in the present embodiment, the consumer of the food or beverage may be a subject other than a human, and the food or beverage may be a feed,

According to the present embodiment, it is also possible to obtain a food or beverage composition which suppresses the expression of an IL-7R gene which is a bone marrow inflammation-related gene, a food or beverage composition which can suppress inflammation of bone marrow, a food or beverage composition which can suppress a reduction of bone density, and a food or beverage composition which improves bone metabolic balance as the food or beverage composition containing a resistant starch-rich starch satisfying the above-mentioned conditions (a) to (d).

Further, according to the present, embodiment, it is also possible to obtain, for example, an effect of preventing or improving osteoporosis.

It is apparent that the present invention is not limited to the above embodiments, that may be modified and changed, without departing from the scope and spirit of the invention.

### EXAMPLES

Examples of the present invention are shown below, but scope and spirit of the present invention are not limited thereto.

Hereafter, “%” refers to “mass %” unless otherwise specified.

### Production Example 1

### Production of Resistant Starch-Rich Starch

A resistant starch-rich starch satisfying the foregoing conditions (a) to (d) was produced in accordance with Example 1 described in International Publication No. WO 2011/045902.

Specifically, high-amylose corn starch HS-7 class VII (manufactured by J-Oil Mills, Inc., water content: 15.0%, and amylose content: 70%) was added with water so as to adjust the dry weight, of starch relative to the weight of slurry to 40% (dry starch weight/slurry weight), to thereby prepare 320 g of slurry. Thereto was added 80 mL of an aqueous 6.67 N hydrochloric acid solution, under stirring, and the temperature was adjusted to 40° C. At this time, the normality of hydrochloric acid relative to reaction water including the water content of the starch was 1.96 N. The time point at which the reaction liquid reached a temperature of 40° C. after addition of the aqueous hydrochloric acid solution was assumed as the start time of reaction. After 24 hours of reaction, the reaction liquid was neutralized with 3% NaOH, followed by washing with water, dehydrating, and drying, to thereby obtain an acid-treated high-amylose corn starch which is a resistant starch-rich starch. Note that the acid normality refers to an acid normality relative to reaction water including the water content of the starch in a final reaction liquid.

The evaluation results of the resulting resistant starch-rich starch are shown below.
Resistant starch content: 68% (measurement method by the AOAC Official Method 2002.02)
Molecular weight peak: 1.2×10⁴
Molecular weight dispersity: 4.0
Gelatinization enthalpy by DSC: 4.9 J/g
Resistant starch content after heating at 200° C. for 20 minutes: 67%

Here, measurements of the molecular weight distribution, the gelatinization enthalpy, and the resistant starch content after heating at 200° C. for 20 minutes were respectively carried out by the following methods.

### (Measurement of Molecular Weight Distribution)

The molecular weight distribution (molecular weight peak and molecular weight dispersity) was measured using an HPLC unit (with a pump DP-8020, an RI detector RS-8021, and a degasser SD-8022, manufactured by Tosoh Corporation). The conditions for analysis are as follows:
Column: TSKgel α-M (7.8 mmφ, 30 cm) (manufactured by Tosoh Corporation)×2;
Flow rate: 0.5 mL/min;
Mobile phase: 5 mM NaNO₃/dimethyl sulfoxide:water (9:1);
Column temperature: 40° C.; and
Analytical volume: 0.2 mL (sample concentration 1.0 mg/mL mobile phase).

Data from the detector was collected using a dedicated software (multi-station GPC-8020 model II, data collection version 5.70, manufactured by Tosoh Corporation), and a molecular weight peak and a molecular weight dispersity were calculated. A standard curve was prepared using pullulan (Shodex Standard P-82, manufactured by Showa Denko K.K.) having a known molecular weight.

### (Measurement of Gelatinization Enthalpy by Differential Scanning Calorimetry (DSC))

DSC was conducted using a DSC3100 (manufactured by MAC Science Corporation). 15 mg of a sample and 45 μL of distilled water were placed in a 70-μL aluminum cell which was then tightly capped and allowed to stand at room temperature for 3 hours or more, so as to allow the sample to absorb water. A blank cell was used as a reference. The sample was heated from room, temperature up to 130° C. at a rate of 10° C./min. Gelatinization enthalpy, which is a quantity of heat measured based on an area of an endothermic peak in the obtained DSC chart, was defined as heat of gelatinization per dry weight of starch (J/g).

(Measurement of Resistant Starch Content after Heating at 200° C. for 20 Minutes)

Starch and water were mixed so as to adjust the water content to 30%, and kneaded twice, 3 seconds for each time, using a Wonder Brender (manufactured by Osaka Chemical Co., Ltd. ). Thereafter, the starch adhered on a side surfaces and a bottom was scraped off using a rubber spatula, and kneaded again for 3 seconds once. 6 g of the thus moisture-controlled starch was taken and filled in a cup made of stainless steel and having a bottom diameter of 52 mm, an opening diameter of 72 mm and a height of 36 mm, and the sample was compressed, by-overlaying thereon a stainless steel cup of the same size and solidified for 10 seconds. The overlaid stainless steel cup was removed, and the sample was heated in an air-blowing constant-temperature drying oven (EYELA WFO-40, manufactured by Tokyo Rikakikai Co., Ltd.) at 200° C. for 20 minutes. The sample after the heating was crushed and sieved through a 60-mesh screen, and the resistant starch content was measured by the measurement method according to the AOAC Official Method 2002.02.

### Test Example 1

### Analysis of Expression Levels of Inflammation-Related Genes in Tibia Bone Marrow

Each feed of Feeds 1 to 3 was prepared using the resistant starch-rich starch obtained by Production Example 1 and the ingredients shown in Table 1. For each feed, the expression levels of inflammation-related genes in tibia bone marrow were analyzed by a two week, test using mice.

The composition of the feeds is shown in Table 1.

TABLE 1

| | Feed 1 | Feed 2 | Feed 3 |
|---|---|---|---|
| | Controlled | 20% HAS | 20% HRS |
| Ingredients (g) | diet | diet | diet |
| Corn starch | 529.5 | 329.5 | 329.5 |
| Milk casein | 200 | 200 | 200 |
| Sucrose | 100 | 100 | 100 |
| Corn oil | 70 | 70 | 70 |
| Cellulose | 50 | 50 | 50 |
| Mineral mix *1 | 35 | 35 | 35 |
| Vitamin mix *2 | 10 | 10 | 10 |
| L-cystine | 3 | 3 | 3 |
| Choline bitartrate | 2.5 | 2.5 | 2.5 |
| t-Butylhydroquinone | 0.014 | 0.014 | 0.014 |
| High-amylose corn | — | 200 | — |
| starch (HAS) *3 | | | |
| Resistant starch- | — | — | 200 |
| rich starch (HRS) of | | | |
| Production Example 1 | | | |
| *4 | | | |
| Total | 1000.014 | 1000.014 | 1000.014 |
| RS content (%) | | 6.9 | 12 |

*1 Mineral mix: AIN-93G mineral mix (manufactured by Oriental Yeast Co., Ltd.)
*2 Vitamin mix: AIN-93 vitamin mix (manufactured by Oriental Yeast Co., Ltd.)
*3 High-amylose corn starch (HAS): High-amylose corn starch HS-7 Class VII (manufactured by J-Oil Mills Co., Ltd.), with a resistant starch content (the value measured according to the AOAC Official Method 2002.02) of 40.5%. When preparing a feed, the RS content of high-amylose corn starch was set to 34.4% (in terms of wet weight).
*4 resistant starch-rich starch (HRS) obtained in Production Example 1, with a resistant starch content (the value measured according to the AOAC Official Method 2002.02) of 68%. When preparing a feed, the RS content of the resistant starch-rich starch was set to 60% (in terms of wet weight).

The test method is as follows.

7.5-week old ddY female mice (manufactured by Japan SLC, Inc.) were used in the test. Animals were subjected to a sham surgery (Sham) or ovariectomy (OVX) after 4 days preliminary breeding. The sham-operated mice were taken as a Sham group. In addition, the ovariectomized mice were divided into an OVX group, a high-araylose corn starch (HAS)-fed group (OVX+HAS group), and a resistant starch-rich starch (HRS) of Production Example 1-fed group (OVX+HRS group). Here, the OVX group is a model group of postmenopausal osteoporosis.

The Sham group and the OVX group received Feed 1 which is a control feed. The OVX+HAS group received a 20% HAS diet of Feed 2. In addition, the OVX+HRS group received a 20% HRS diet of Feed 3. Here, each group was given the above-mentioned feed for 2 weeks by paired feeding.

Each mouse was raised in an individual cage and kept in a room conditioned at a room temperature of 23±1° C., a humidity of 60±5%, and a 12-hour light/12-hour dark cycle. The feed intake amount of animals during the breeding period was recorded from time to time, and animals were given ad libitum access to drinking water.

After breeding for 2 weeks, tibiae were collected from, mice under nembutal anesthesia, and immersed in 70% ethanol and stored at 4° C. until analysis.

Then, expression levels of inflammation-related genes in tibia bone marrow of each group of mice were analyzed according to the following method.

Total RNA was extracted from the tibia bone marrow using ISOGEN II (manufactured by Nippon Gene Co., Ltd.) as an RNA extraction reagent. For the synthesis of cDNA from RNA, a Prime Script RT Master Mix (manufactured by Takara Bio Inc.) was used. For the real-time PGR analysis, a MiniOpticon Real-time PGR System (manufactured, by Bio-Rad Laboratories, Inc.) was used and a SYBR Primer Ex Taq II (manufactured by Takara Bio Inc.) was used as a PGR reaction reagent. The real-time PGR reaction was carried out under the following conditions: initial denaturation at 95° C. for 30 seconds, followed by 40 cycles of denaturation at 95° C. for 5 seconds and annealing at 60° C. for 30 seconds.

Primers used are shown below.
Interleukin (IL)-7-F:
(SEQ ID NO: 1)
TCCTCCACTGATCCTTGTTC
IL-7-R:
(SEQ ID NO: 2)
CTTCAACTTGCGAGCAGCAC
Interleukin 7 receptor (IL-7R)-F:
(SEQ ID NO: 3)
GCGGACGATCACTCCTTCTG
IL-7R-R:
(SEQ ID NO: 4)
AGCCCCACATATTTGAAATTCCA
Tumor necrosis factor (TNF)-α-F:
(SEQ ID NO: 5)
ATGAGCACAGAAAGCATGATC
TNRF-α-R:
(SEQ ID NO: 6)
TACAGGCTTGTCACTCGAATT
IL1β-F:
(SEQ ID NO: 7)
TGCCACCTTTTGACAGTGAT
IL1β-R:
(SEQ ID NO: 8)
CGAGATTTGAAGCTGGATGC

In addition, the measurement results of the gene expression levels were subjected to a statistical analysis by the following method.

The analysis was carried out using a SPSS Statics, Ver 19.0 J for Windows (manufactured by IBM Corporation). The results are expressed as a mean±standard error. All values were subjected to a removal of outliers from, normally distributed, data sets using the Smirnov-Grubbs test and then each test was carried out. A significant; difference test on the gene expression levels between groups was carried out by one-way analysis of variance (AMOVA) followed by a Tukey's multiple comparison test. The probability of the judgment criteria was a significance level of 5%.

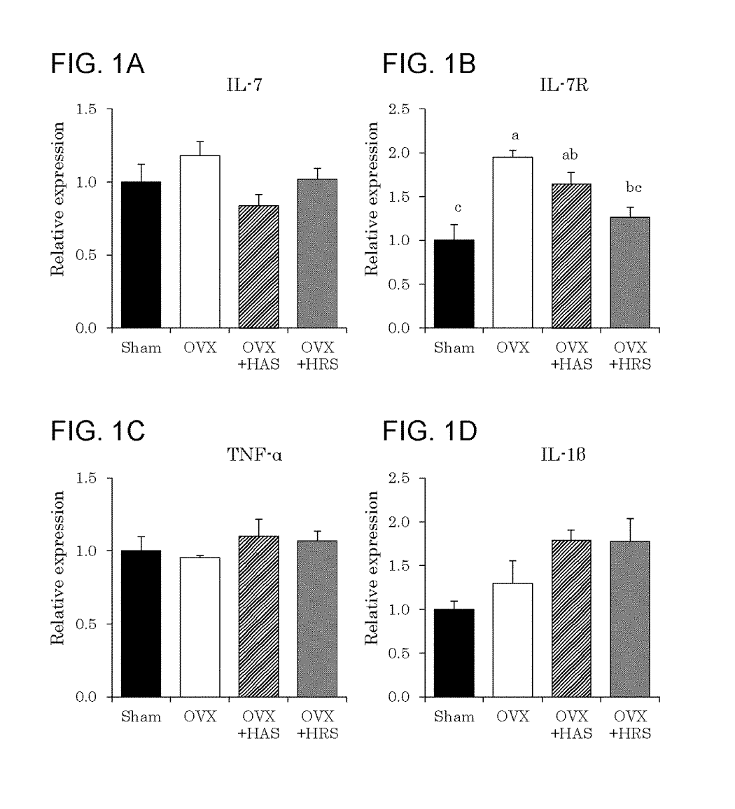

FIG. 1A to FIG. 1D are diagrams showing the analysis results. In each figure, there is a significant difference between different symbols of a to c for gene expression levels (“Relative expression” in the FIG.) (P<0.05).

From FIG. 1A to FIG. ID, the following can be seen about the effect of two weeks' intake of each feed on the expression of inflammation-related genes in bone marrow of an osteoporosis model mouse.

As can be seen from. FIG. 1B, the expression level of the IL-7R gene in the estrogen-deficient OVX group was significantly higher than that in the Sham group. In the OVX+HAS group fed with Feed 2, there was no significant difference from the OVX group in the expression level of the IL-7R gene.

On the other hand, in the OVX+HRS group fed with Feed 3, there was a significant low expression level of the IL-7R gene.

With respect to expression levels of IL-7, TNF-α, and IL-1β genes in the bone marrow, no significant effect was observed in the OVX+HRS group (FIG. 1A, FIG. 1C, and FIG. 1D),

### Test Example 2

### Analysis of Femoral Bone Density

In accordance with Test Example 1, Feeds 1 to 3 were prepared using the resistant starch-rich starch obtained in Production Example 1 and the ingredients shown in Table 1.

With respect to individual feeds, the effect of each feed on the femoral bone density was investigated by a 6-week study using mice.

The test method is as follows.

Mice of Sham group, OVX group, OVX+HAS group, and OVX+HRS group were prepared in accordance with the method of Test Example 1.

Each mouse was raised in an individual cage and kept in a room conditioned at a room temperature of 23±1° C., a humidity of 60±5%, and a 12-hour light/12-hour dark cycle. The feed intake amount of animals during the breeding period was recorded from time to time, and animals were given ad libitum access to drinking water.

After breeding for 6 weeks, cardiac blood was collected from mice under nembutal anesthesia, and femurs were collected, and immersed in 70% ethanol and then stored at 4° C. until analysis.

The bone density of the excised left femur was measured by a dual-energy X-ray absorptiometry (DXA) method using a DCS-600 EX-R (manufactured by Aloka Co., Ltd.). The bone density was calculated by dividing a bone mineral content by a bone area. Analysis was done for whole femur and for 3 equal divisions which are a proximal femur, femur diaphyseal, and distal femur.

In addition, the measurement results of the bone density were subjected to a statistical analysis by the following method.

The analysis was carried out using a SPSS Statics, Ver 19.0 J for Windows (manufactured by IBM Corporation). The results are expressed as a mean±standard error. All values were subjected to removal of outliers from normally distributed datasets using the Smirnov-Grubbs test and then each test was carried out. A significant difference test on the bone density was carried out by a covariance analysis (ANCOVA) taking the body weight as a covariate, followed by a Fisher's multiple comparison test.

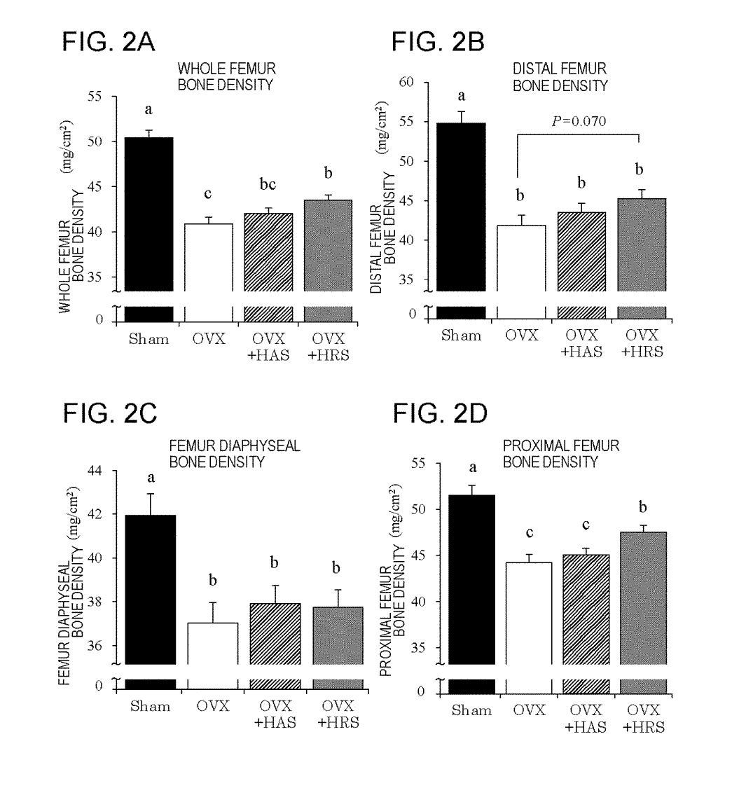

FIG. 2A to FIG. 2D are diagrams showing the measurement results of whole femur bone density, distal femur bone density, femur diaphyseal bone density, and proximal femur bone density, respectively. With respect to the bone density in each figure, there is a dominant difference between different symbols of a to c (P<0.05),

From FIG. 2A to FIG. 2D, the following can be seen about the effect of six weeks intake of each feed on the femoral bone density of an osteoporosis model mouse.

As can be seen from FIG. 2A, the whole femur bone density of the estrogen-deficient OVX group was significantly lower than that of the Sham, group. In the OVX+HAS group fed with Feed 2, there was no significant difference in the reduction of bone density due to estrogen deficiency.

On the other hand, in the OVX+HRS group fed with Feed 3, there was a significant suppression in the reduction of bone density due to estrogen deficiency.

In addition, as can be seen from FIG. 2B, the same tendency was observed also in the distal femur.

As can be seen from FIG. 2C, there was no significant effect of intake of Feed 2 and Feed 3 on the femur diaphyseal.

In addition, as can be seen from FIG. 2D, in the OVX+HRS group fed with Feed 3, a reduction of bone density due to estrogen deficiency was significantly suppressed also in the proximal femur.

It is apparent that the present invention is not limited to the above embodiments, and may be modified and changed without departing from the scope and spirit of the invention.

What is claimed is:

1. A food or beverage composition for suppressing an expression of an interleukin 7 receptor (IL-7R) gene, comprising a resistant starch-rich starch satisfying the following conditions (a), (b), (c) and (d) as an active ingredient:
(a) having a resistant starch content of 60% or more, as determined by the AOAC Official Method 2002.02 for measuring resistant starch,
(b) having a molecular weight peak more than or equal to 6×10³ and less than or equal to 4×10⁴
(c) having a molecular weight dispersity more than or equal to 1.5 and less than or equal to 6.0, and
(d) having a gelatinization enthalpy at 50 ° C. to 130° C. of 10 J/g or less, as measured by differential scanning calorimetry.

2. The food or beverage composition for suppressing the expression of the IL-7R gene according to claim 1, wherein the resistant starch-rich starch is an acid-treated product of an amylose-rich starch having an amylose content of 40% or more.

3. The food or beverage composition for suppressing the expression of the IL-7R gene according to claim 1, wherein a content, of the resistant starch-rich starch in the food or beverage composition for suppressing the expression, of the IL-7R gene is more than or equal to 0.1 mass % and less than 100 mass % with respect to a total amount of the food or beverage composition for suppressing the expression of the IL-7R gene.

4. A food or beverage composition for suppressing an inflammation of a bone narrow, comprising a resistant starch-rich starch satisfying the following conditions (a), (b), (c) and (d) as an active ingredient:
(a) having a resistant starch content of 60% or more, as determined by the AOAC Official Method 2002.02 for measuring resistant starch,
(b) having a molecular weight peak more than or equal to 6×10³ and less than or equal to 4×10⁴,
(c) having a molecular weight dispersity more than or equal to 1.5 and less than or equal to 6.0, and
(d) having a gelatinization enthalpy at 50° C. to 130° C. of 10 J/g or less, as measured by differential scanning calorimetry.

5. The food or beverage composition for suppressing the inflammation of the bone marrow according to claim 4, wherein the resistant starch-rich starch is an acid-treated product of an amylose-rich starch having an amylose content of 40% or more.

6. The food or beverage composition for suppressing the inflammation of the bone marrow according to claim 4, wherein a content of the resistant starch-rich starch in the food or beverage composition for suppressing the inflammation of the bone marrow is more than or equal to 0.1 mass % and less than 100 mass % with respect to a total amount of the food or beverage composition for suppressing the inflammation of the bone marrow.

7. A food or beverage composition for suppressing a reduction of a bone density, comprising a resistant starch-rich starch satisfying the following conditions (a), (b), (c) and (d) as an active ingredient:
(a) having a resistant starch content of 60% or more, as determined by the AOAC Official Method 2002.02 for measuring resistant starch,
(b) having a molecular weight peak more than or equal to 6×10³ and less than or equal to 4×10⁴,
(c) having a molecular weight dispersity more than or equal to 1.5 and less than or equal to 6.0, and
(d) having a gelatinization enthalpy at 50° C. to 130° C. of 10 J/g or less, as measured by differential scanning calorimetry.

8. The food or beverage composition for suppressing the reduction of the bone density according to claim 7, wherein the resistant starch-rich starch is an acid-treated product of an amylose-rich starch having an amylose content of 40% or more.

9. The food or beverage composition for suppressing the reduction of the bone density according to claim 7, wherein a content of the resistant starch-rich starch in the food or beverage composition for suppressing the reduction of the bone density is more than or equal to 0.1 mass % and less than 100 mass % with respect to a total amount of the food or beverage composition for suppressing the reduction of the bone density.

10. A food or beverage composition for improving a bone metabolic balance, comprising a resistant starch-rich starch satisfying the following conditions (a), (b), (c) and (d) as an active ingredient:
(a) having a resistant starch content of 60% or more, as determined by the AOAC Official Method 2002.02 for measuring resistant starch,
(b) having a molecular weight peak more than or equal to 6×10³ and less than or equal to 4×10⁴,
(c) having a molecular weight dispersity more than or equal to 1.5 and less than or equal to 6.0, and
(d) having a gelatinization enthalpy at 50° C. to 130° C. of 10 J/g or less, as measured by differential scanning calorimetry.

11. The food or beverage composition for improving the bone metabolic balance according to claim 10, wherein the resistant starch-rich starch is an acid-treated product of an amylose-rich starch having an amylose content of 40% or more.

12. The food or beverage composition for improving the bone metabolic balance according to claim 10, wherein a content of the resistant starch-rich starch in the food or beverage composition for improving the bone metabolic: balance is more than or equal to 0.1 mass % and less than 100 mass % with respect to a total amount of the food or beverage composition for improving the bone metabolic balance.


SEQUENCE LISTING (8 sequences)

SEQ ID NO: 1 - DNA, 20 bp, Artificial Sequence
  Oligonucleotide to act as a PCR primer
tcctccactgatccttgttc

SEQ ID NO: 2 - DNA, 20 bp, Artificial Sequence
  Oligonucleotide to act as a PCR primer
cttcaacttgcgagcagcac

SEQ ID NO: 3 - DNA, 20 bp, Artificial Sequence
  Oligonucleotide to act as a PCR primer
gcggacgatcactccttctg

SEQ ID NO: 4 - DNA, 23 bp, Artificial Sequence
  Oligonucleotide to act as a PCR primer
agccccacatatttgaaattcca

SEQ ID NO: 5 - DNA, 21 bp, Artificial Sequence
  Oligonucleotide to act as a PCR primer
atgagcacagaaagcatgatc

SEQ ID NO: 6 - DNA, 21 bp, Artificial Sequence
  Oligonucleotide to act as a PCR primer
tacaggcttgtcactcgaatt

SEQ ID NO: 7 - DNA, 20 bp, Artificial Sequence
  Oligonucleotide to act as a PCR primer
tgccaccttttgacagtgat

SEQ ID NO: 8 - DNA, 20 bp, Artificial Sequence
  Oligonucleotide to act as a PCR primer
cgagatttgaagctggatgc